(19) United States
(12) Patent Application Publication
(10) Pub. No.: US 2023/0193796 A1
(43) Pub. Date: Jun. 22, 2023

(54) MUFFLER VALVE AND MUFFLER

(71) Applicant: SANKEI GIKEN KOGYO CO., LTD., Tokyo (JP)

(72) Inventor: Hidetoshi Sugimoto, Isesaki-shi (JP)

(73) Assignee: SANKEI GIKEN KOGYO CO., LTD., Tokyo (JP)

(21) Appl. No.: 17/926,684

(22) PCT Filed: Mar. 22, 2021
(86) PCT No.: PCT/JP2021/011823

§ 371 Date: Nov. 21, 2022

(30) Foreign Application Priority Data
May 25, 2020 (JP) 2020-090912

(51) Int. Cl. F01N 1/16; F16K 15/03

(52) U.S. Cl. CPC F01N 1/163; F01N 1/166; F16K 15/033

(57) ABSTRACT

Provided is a muffler valve 1 that opens and closes an exhaust passage according to a pressure of an exhaust gas of an engine. A valve body 3 is swingably supported by a support shaft 4 with respect to a valve seat 2 having an opening 22, the valve body 3 is urged in a closing direction by a coil spring 5 externally inserted on the support shaft 4, a valve seat hook portion 23 is provided so as to embrace both ends of the support shaft 4 in a circumferential direction and is fixed to the support shaft 4, and a valve body winding portion 34 is provided so as to embrace the coil spring 5 in the circumferential direction from a direction opposite to the valve seat hook portion 23 and embrace the coil spring 5 over an entire length of the coil spring 5 in the circumferential direction. It is possible to prevent or suppress axial misalignment of the coil spring coaxially externally inserted on the support shaft for opening and closing the valve body as much as possible, and appropriately control the opening and closing of the valve body with high stability.

### TECHNICAL FIELD

The present invention relates to a muffler valve that is installed in a muffler of an automobile exhaust system and opens and closes an exhaust passage according to the pressure of an exhaust gas of an engine and a muffler having the same.

### TECHNICAL FIELD

Conventionally, Patent Literature 1 discloses an example of a muffler valve that is installed in a muffler of an automobile exhaust system and opens and closes an exhaust passage according to the pressure of an exhaust gas of an engine. This muffler valve has a valve body support member corresponding to a valve seat and a valve body. The valve body support member is provided with a tapered portion and a cylindrical portion extending rearward from an inner peripheral edge of a central hole of the main body, and a wire mesh is fixed to the inner peripheral surface of the tapered portion. The cylindrical portion is fitted to a flange cut up at the opening of a separator that partitions the inside of the muffler, and the valve body support member is attached to the separator. An upright portion that stands up in the direction opposite to the tapered portion is formed on the outer peripheral edge of the main body of the valve body support member, and a pair of ear-shaped stays are formed on both the left and right sides of an upper portion of the upright portion so as to project further from the upright portion.

The valve body is provided with a substantially truncated cone-shaped protrusion near the center, the outer peripheral surface thereof is formed in a shape that overlaps and matches the wire mesh fixed to the tapered portion. An upright portion that stands up in the direction opposite to the protrusion is formed on the outer peripheral edge of the valve body. A pair of ear-shaped stays are formed on both the left and right sides of the upper portion of the upright portion so as to project further from the upright portion. The pair of stays of the valve body are disposed so as to overlap the stays of the valve body support member, and the valve body is swingably attached to the valve body support member via a pin corresponding to a support shaft. A coil spring is coaxially externally inserted on this pin, and the coil spring has one arm fixed to the valve body support member, and the other arm pressing the valve body so as to close the valve body.

### CITATION LIST

### Patent Literature

[PTL 1] Japanese Patent Application Publication No. 9-195749

### SUMMARY OF INVENTION

### Technical Problem

By the way, when the coil spring is coaxially externally inserted on the support shaft for opening and closing the valve body, as in the muffler valve of Patent Literature 1, the larger the difference between the outer diameter of the support shaft and the inner diameter of the coil body of the coil spring, the more unpredictable axial misalignment is likely to occur at the design stage after assembly. If such axial misalignment occurs, the closing load for closing the valve body will vary, making it difficult to properly control the opening and closing of the valve body. In addition, the likelihood of axial misalignment to occur increases the number of prototypes when developing an improved product that meets detailed product specification changes, resulting in an increase in development costs and a longer development period.

Further, when the muffler valve of Patent Literature 1 is assembled, a pair of ear-shaped stays protruding from the left and right sides of the upper portion of the valve seat and a pair of ear-shaped stays protruding from the left and right sides of the upper portion of the valve body are held by a jig in a state where support shaft insertion holes thereof are aligned so as to overlap each other. The support shaft insertion holes and the coil bodies of the coil springs are coaxially positioned and held by a jig between the support shaft insertion holes. In this state, the support shafts are inserted into the coil springs between the support shaft insertion holes whereby the muffler valve is assembled. As a result, the number of jigs for positioning and holding the parts used during manufacturing increases, the manufacturing cost increases, and the manufacturing process becomes complicated, resulting in a decrease in manufacturing efficiency.

The present invention has been proposed in view of the above problems, and an object of the present invention is to provide a muffler valve and a muffler which can prevent or suppress axial misalignment of a coil spring that is coaxially externally inserted on a support shaft for opening and closing a valve body as much as possible and control opening and closing of the valve body appropriately with high stability, and can reduce the number of prototypes when developing an improved product that meets detailed product specification changes, reduce development costs, and shorten the development period. Another object of the present invention is to provide a muffler valve and a muffler which can reduce the number of jigs for positioning and holding parts used during manufacturing, reduce manufacturing costs, and improve manufacturing efficiency by simplifying the manufacturing process.

### Solution to Problem

A muffler valve according to the present invention is a muffler valve that opens and closes an exhaust passage according to a pressure of an exhaust gas of an engine, wherein a valve body is swingably supported by a support shaft with respect to a valve seat having an opening, the valve body is urged in a closing direction by a coil spring externally inserted on the support shaft, a valve seat hook portion is provided so as to embrace both ends of the support shaft in a circumferential direction and is fixed to the support shaft, and a valve body winding portion is provided so as to embrace the coil spring in the circumferential direction from a direction opposite to the valve seat hook portion and embrace the coil spring over an entire length of the coil spring in the circumferential direction.

According to this configuration, the valve seat hook portion of the valve seat is provided so as to embrace both ends of the support shaft in the circumferential direction and is fixed to the support shaft. The valve body winding portion is provided so as to embrace the coil spring in the circumferential direction from the direction opposite to the valve seat hook portion and to embrace the coil spring in the circumferential direction over the entire length of the coil spring. Therefore, it is possible to prevent or suppress axial misalignment of the coil body of the coil spring externally inserted on the support shaft for opening and closing the valve body so as to be coaxial with the support shaft as much as possible and appropriately control the opening and closing of the valve body with high stability. In addition, by preventing and suppressing axial misalignment as much as possible, it is possible to reduce the number of prototypes when developing an improved product of the muffler valve that meets detailed product specification changes, thereby reducing development costs and shortening the development period. In addition, since it is possible to assemble by inserting the coil spring and the support shaft into the valve body winding portion, it is possible to reduce the number of jigs for positioning and holding the parts used during manufacturing and reduce manufacturing costs and increase manufacturing efficiency by simplifying the manufacturing process.

In the muffler valve of the present invention, one arm of the coil spring may be led out and disposed on a front side of the valve body substrate of the valve body near a root of the valve body winding portion, and the other arm may be led out and disposed on a back side near a root of the valve seat hook portion, and the valve body may be urged in a closing direction by one arm of the coil spring.

According to this configuration, one arm of the coil spring is led out and disposed on the front side of the valve body substrate of the valve body near the root of the valve body winding portion, and the other arm is led out and disposed on the back side near the root of the valve seat hook portion so that the valve body is urged in the closing direction by one arm. Therefore, the valve body provided so that the valve body winding portion embraces the coil spring in the circumferential direction can be always urged in the closing direction.

In the muffler valve of the present invention, a notch in which the other arm of the coil spring is led out to the back side near the root of the valve seat hook portion may be formed in the valve body substrate near a rising portion of the valve body winding portion of the valve body.

According to this configuration, due to the notch, the other arm of the coil spring can be easily led out to the back side near the root of the valve seat hook portion while providing the valve body winding portion so as to embrace the coil spring in the circumferential direction over the entire length. In addition, by using the notch instead of the hole as the position at which the other arm is led out to the back side, the muffler valve can be smoothly assembled with a simple manufacturing process by externally inserting the coil spring on the support shaft from the notch side.

In the muffler valve of the present invention, a restricting projection that restricts movement of the other arm of the coil spring in an axial direction of a support shaft may be provided at a position inner than the valve seat hook portion of the valve seat.

According to this configuration, it is possible to restrict the movement of the coil spring in the axial direction of the support shaft and enhance the stability of the operation of opening and closing the valve body of the muffler valve.

In the muffler valve of the present invention, the valve seat hook portion may be provided so as to embrace both ends of the support shaft in the circumferential direction from the valve body side and is fixed to the support shaft, and the valve body winding portion may be provided so as to embrace the coil spring in the circumferential direction from the valve seat side, and may be provided so as to protrude from the valve body substrate of the valve body in a direction opposite to the valve seat.

According to this configuration, it is possible to prevent and suppress axial misalignment of the coil spring externally inserted on the support shaft for opening and closing the valve body so as to be coaxial with the support shaft as much as possible. Moreover, it is possible to eliminate the bulkiness of the valve body winding portion toward the valve seat side, reduce the thickness of the valve body substrate of the valve body and the valve seat, and enhance handleability when the muffler valve is attached to the separator or the like.

In the muffler valve of the present invention, the valve seat substrate of the valve seat may be formed in a substantially flat-plate ring shape having an opening at the center, and the valve body substrate of the valve body may be formed in a flat dish shape having a flat rim.

According to this configuration, the valve seat substrate of the valve seat of the muffler valve is formed in a substantially flat-plate ring shape having the opening at the center, and the valve body substrate of the valve body is formed in a flat dish shape having the flat rim. As a result, the muffler valve can be made compact by eliminating the bulkiness and minimizing the thickness. Therefore, the handleability of the muffler valve during attachment can be improved. In addition, the materials used for manufacturing can be reduced, the manufacturing cost can be reduced, and the weight can be reduced as the materials used are reduced, which can contribute to the improvement of the fuel efficiency of the automobile. When the muffler valve is attached to the separator that partitions the inside of the muffler, for example, the flat-plate ring-shaped valve seat substrate can be disposed and attached near the peripheral edge of the opening of the separator, eliminating the need for additional machining such as forming a flange in the opening of the separator. From this point of view, it is possible to reduce the manufacturing cost of the muffler and improve the manufacturing efficiency. Since a portion of the separator is not cut up to reduce the strength of the separator and the separator is not repeatedly subjected to bending stress, it is possible to maintain the high durability of the muffler.

A muffler of the present invention is a muffler in which the valve seat substrate of the valve seat of the muffler valve according to the present invention is fixed to a peripheral edge of an opening of a separator that partitions the inside of the muffler.

According to this configuration, a muffler having the effects of the muffler valve of the present invention can be obtained.

A method for manufacturing the muffler valve of the present invention includes a process of inserting the coil spring into the valve body winding portion so that one arm of the coil spring is inserted into a gap between the valve body substrate and a tip surface of the valve body winding portion formed by being bent in a hook shape so as to be folded back from the valve body substrate of the valve body and inserting the support shaft into the valve body winding portion so as to be inserted into the coil body of the coil spring.

According to this configuration, it is possible to reduce the number of jigs for positioning and holding the parts to be used, such as, for example, jigs for positioning and holding the coil body. Therefore, it is possible to reduce the manufacturing costs of the muffler valve capable of preventing or suppressing the axial misalignment of the coil body of the coil spring externally inserted on the support shaft for opening and closing the valve body so as to be coaxial with the support shaft as much as possible and enhance the manufacturing efficiency by simplifying the manufacturing process.

### Advantageous Effects of Invention

According to the present invention, it is possible to prevent or suppress axial misalignment of a coil spring that is coaxially externally inserted into a support shaft for opening and closing a valve body as much as possible and control opening and closing of the valve body appropriately with high stability, and can reduce the number of prototypes when developing an improved product that meets detailed product specification changes, reduce development costs, and shorten the development period. Moreover, it is possible to reduce the number of jigs for positioning and holding parts used during manufacturing, reduce manufacturing costs, and improve manufacturing efficiency by simplifying the manufacturing process.

### BRIEF DESCRIPTION OF DRAWINGS

FIG. 1 is a perspective view of the closed state of a muffler valve according to an embodiment of the present invention as viewed from the valve plate side

FIG. 2 is a perspective view of the open state of the muffler valve of the embodiment as viewed from the valve seat side.

FIG. 3(a) is an enlarged perspective view of the vicinity of the notch of the muffler valve of the embodiment in the closed state as viewed from the valve plate side, and FIG. 3(b) is an enlarged perspective view of the vicinity of the notch of the muffler valve of the embodiment in the open state as viewed from the valve seat side.

FIG. 4 is a vertical cross-sectional view of the closed state of the muffler valve of the embodiment.

FIG. 5(a) is a front perspective view of the closed state of the muffler valve of the embodiment, and FIG. 5(b) is a cross-sectional view along the line A-A.

FIG. 6(a) is a front perspective view of a part of the muffler valve of the embodiment in the closed state, and FIG. 6(b) is a rear perspective view of a part of the muffler valve of the embodiment in the open state.

FIG. 7 is an explanatory view of a muffler in which the muffler valve of the embodiment is attached to a separator.

FIG. 8 is a front view of a state in which the muffler valve of the embodiment is attached to a separator.

FIG. 9 is a vertical cross-sectional view of a state in which the muffler valve of the embodiment is attached to a separator.

FIGS. 10(a) to 10(c) are explanatory views for explaining the first-half manufacturing process of the muffler valve of the embodiment.

FIGS. 11(a) and 11(b) are explanatory views for explaining the second-half manufacturing process of the muffler valve of the embodiment.

FIGS. 12(a) to 12(c) are explanatory views for explaining the second-half manufacturing process of the muffler valve according to the modified example of the embodiment.

### DESCRIPTION OF EMBODIMENTS

### [Muffler Valve of Embodiment]

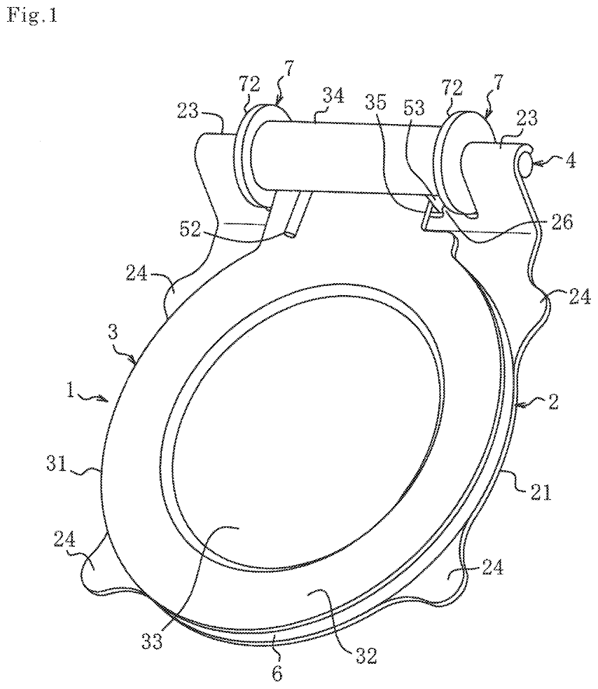

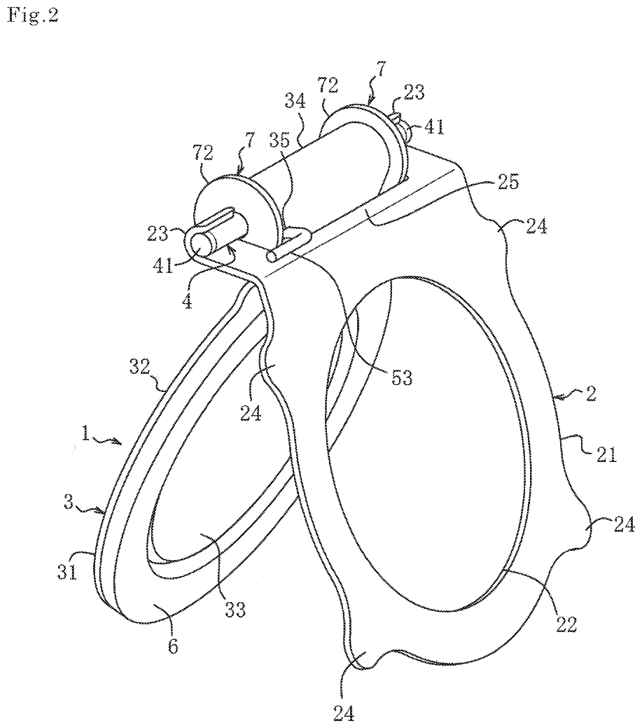

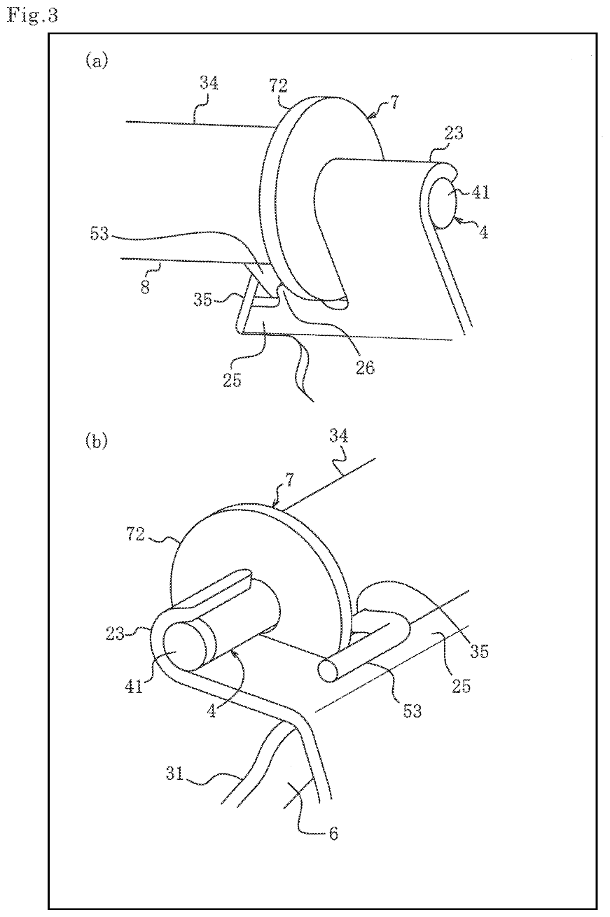

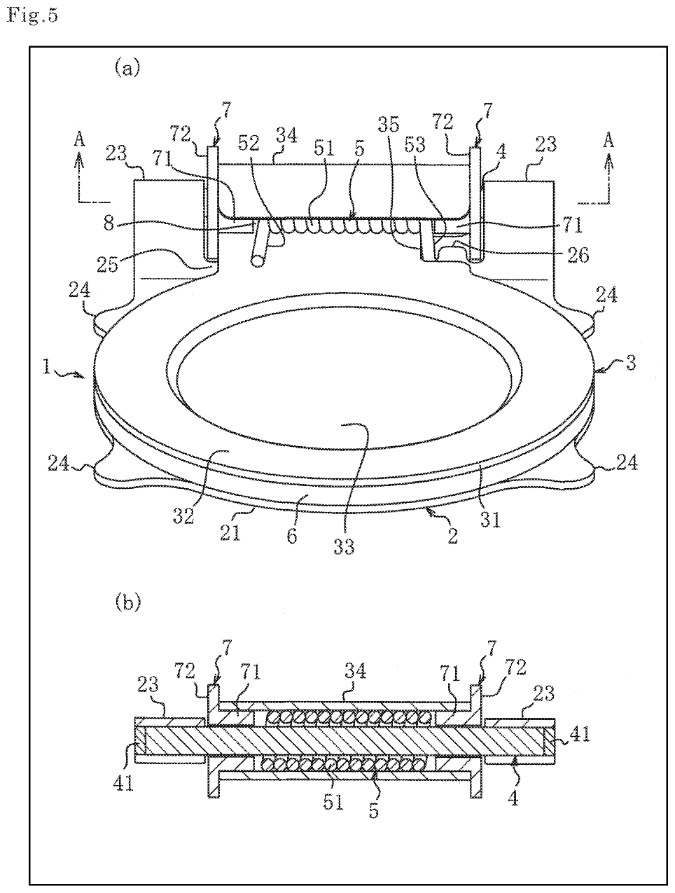

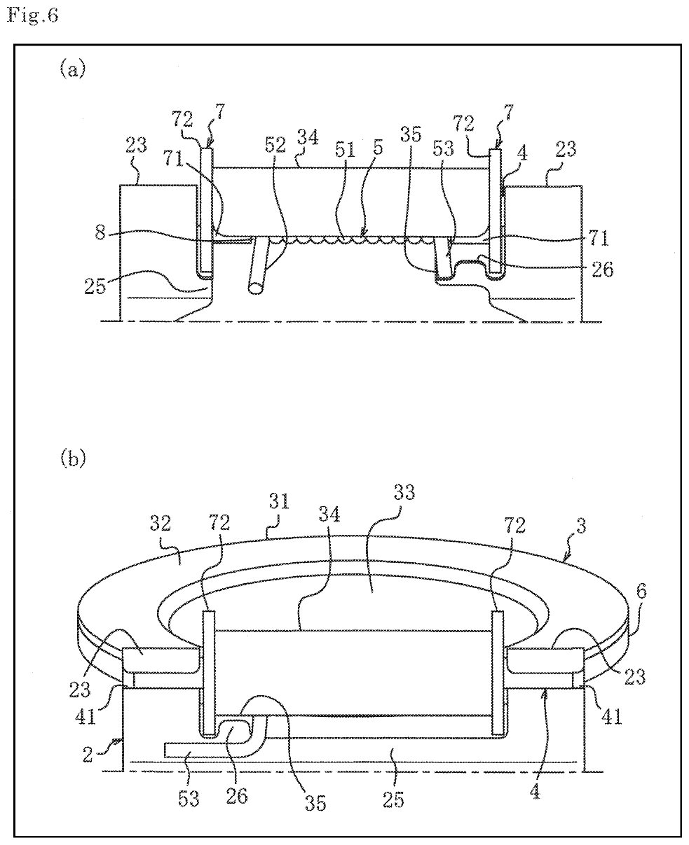

A muffler valve 1 of a first embodiment according to the present invention is installed in a muffler of an exhaust system of an automobile and opens and closes an exhaust passage according to the pressure of an exhaust gas of the engine. Preferably, the muffler valve 1 is attached to a separator that partitions the inside of the muffler. As shown in FIGS. 1 to 6, the muffler valve 1 includes a valve seat 2, a valve body 3 that opens and closes, a support shaft 4, and a coil spring 5. The valve body 3 is swingably supported by the support shaft 4 with respect to the valve seat 2, and is urged in a closing direction by the coil spring 5 externally inserted on the support shaft 4.

The valve seat 2 has a valve seat substrate 21 formed in a substantially flat-plate ring shape disposed along the separator, for example, and an opening 22 constituting an exhaust passage opened and closed is formed at the center of the valve seat substrate 21. The valve seat 2 is provided with a pair of valve seat hook portions 23, 23 at intervals on both sides of the valve seat substrate 21. The valve seat hook portion 23 rises obliquely upward from the upper end in the drawing of the valve seat substrate 21 and is curved in an arc shape on the back side of the valve body substrate 21, and is formed integrally with the valve seat substrate 21.

The pair of valve seat hook portions 23, 23 are provided near both ends of the support shaft 4. The valve seat hook portion 23 in the illustrated example is engaged with the support shaft 4 so as to embrace both ends of the support shaft 4 in the circumferential direction from the valve body 3 side. The valve seat hook portion 23 is fixed to the support shaft 4 by a welding portion 41 formed on both ends of the support shaft 4. The inner peripheral surface of the tip end of the valve seat hook portion 23 has a shape and a size that substantially follow the shape and size of the outer peripheral surface of the support shaft 4 to be engaged.

The valve seat substrate 21 of the valve seat 2 is provided with welding regions 24 protruding outward from the outer peripheral edge of the valve body substrate 31 of a closed valve body 3 to be described later on the support shaft 4 side and the side opposite to the support shaft 4. In the illustrated example, four welding regions 24 are provided in total including two on the support shaft 4 side and two on the opposite side of the support shaft 4, and each welding region 24 is formed in a tongue shape. The welding region 24 is used, for example, as a place for welding when attaching the muffler valve 1 to the separator of the muffler by welding.

The valve body 3 has a valve body substrate 31, and the valve body substrate 31 is formed in a flat dish shape having a flat rim 32. A recess 33 having a substantially circular shape in a plan view, which is recessed so as to protrude toward the valve seat 2 side is provided on the front surface of the valve body substrate 31. The flat rim 32 is formed in a ring shape around the recess 33 or the protruding portion of the recess 33. A ring cushioning member 6 having a substantially flat-plate ring shape is fixed by welding or the like to the valve seat 2 side of the flat rim 32. As the ring cushioning member 6, it is possible to use an appropriate cushioning member having a cushioning function such as elasticity and heat resistance, and for example, a metal mesh material is preferable. When the thickness of the opening/closing region where the valve body substrate 31 is laminated on the valve seat substrate 21 in the closed state is within the lamination thickness in the closed state of the flat rim 32 of the valve body 3, the ring cushioning member 6, and the valve seat substrate 21, it is possible to suppress an increase in the thickness of the opening/closing region, which is more preferable.

The valve body 3 is formed with a valve body winding portion 34 that protrudes from the support shaft 4 side of the valve body substrate 31 and is curved in a hook shape so as to be folded back from the valve body substrate 31. The valve body winding portion 34 is formed integrally with the valve body substrate 31 so as to protrude from the valve body substrate 31 in the direction opposite to the valve seat 2 in the closed state. The inner peripheral surface of the valve body winding portion 34 has a shape and a size that substantially follow the shape and size of the outer peripheral surface of the coil body 51 of the coil spring 5. The size of the inner peripheral surface of the valve body winding portion 34 is slightly larger than the size of the outer peripheral surface of the coil body 51.

The valve body winding portion 34 is curved in an arc shape exceeding a semicircle, preferably an arc shape exceeding ¾ circle or approximately ¾ circle in a cross-sectional view. The valve body winding portion 34 is provided so as to embrace the coil spring 5 externally inserted into the support shaft 4 in a circumferential direction from the direction opposite to the direction in which the valve seat hook portion 23 embraces the support shaft 4 in the circumferential direction. In the present embodiment, the valve body winding portion 34 is provided so as to embrace the coil spring 5 in the circumferential direction from the valve seat side.

The valve body winding portion 34 is formed so as to extend in the width direction at substantially the center of the width direction of the valve body substrate 31. The valve body winding portion 34 is formed so as to extend in an elongated manner in a row by a length that fits between the pair of valve seat hook portions 23, 23 of the valve seat 2. The valve body winding portion 34 extending in an elongated manner in a row is provided so as to embrace the coil spring 5 externally inserted on the support shaft 4 in the circumferential direction over the entire length of the coil spring 5.

A cylinder cushioning member 7 including a cylindrical portion 71 and a flange 72 protruding outward from one axial end of the cylinder portion 71 is provided at both ends of the valve body winding portion 34. The cylinder cushioning members 7, 7 are fixed by internally fitting the cylindrical portions 71, 71 to both ends of the valve body winding portion 34 in a state in which the support shaft 4 and the coil spring 5 are internally fitted to the valve body winding portion 34. The flange 72 is brought into contact with the end surface of the valve body winding portion 34 in the width direction by the internal fitting of the cylindrical portion 71. The flange 72 is disposed between the end surface of the valve body winding portion 34 in the width direction and the inner end surface of the valve seat hook portion 23 of the valve seat 2, and is disposed near the inner end surface of the valve seat hook portion 23.

The valve body winding portion 34 is engaged with the support shaft 4 inserted through the cylinder cushioning members 7, 7 via the cylinder cushioning members 7, 7. In other words, the cylinder cushioning members 7, 7 fitted to the valve body winding portion 34 serve as bearings for the support shaft 4 in the valve body 3. As the cylinder cushioning member 7, it is possible to use an appropriate cushioning member having a cushioning function such as elasticity and heat resistance, and for example, a metal mesh material is preferable.

The coil body 51 of the coil spring 5 in the wound state is disposed inside the valve body winding portion 34 over its entire length and is externally inserted on the support shaft 4. One arm 52 of the coil spring 5 is led out and disposed on the front side (in the illustrated example, on the front side of the flat rim 32) of the valve body substrate 31 of the valve body 3 near the root of the valve body winding portion 34. The other arm 53 of the coil spring 5 is led out and disposed on the back side of the rising portion of the valve seat hook portion 23 near the root of the valve seat hook portion 23. The valve body 3 is urged in the closing direction by one arm 52 of the coil spring 5.

A notch 35 is formed on one side in the width direction of the valve body substrate 31 near the rising portion of the valve body winding portion 34 of the valve body 3. The other arm 53 of the coil spring 5 is led out from the notch 35 toward the back side of the valve body substrate 31. The other arm 53 of the coil spring 5 is led out toward the back side in the vicinity of the root of the valve seat hook portion 23 via the space between the notch 35 and the valve seat hook portions 23, 23. The other arm 53 of the coil spring 5 is disposed so as to press and urge the rising portion of the valve seat hook portion 23 from the back side.

An upright portion 25 that rises at a height lower than the rising portion of the valve seat hook portion 23 and at the same angle as the rising portion is formed between the valve seat hook portions 23, 23 of the valve seat 2. A restricting protrusion 26 that locally protrudes from the upright portion 25 is provided at a position inner than the valve seat hook portion 23 on the side where the notch 35 is provided. The other arm 53 of the coil spring 5 passes through a space surrounded by the notch 35, the tip surface of the upright portion 25, and the restricting protrusion 26, and is led out to the back side near the root of the valve seat hook portion 23. The other arm 53 is sandwiched between the inner end surface of the restricting protrusion 26 and the end surface of the notch 35, whereby the movement of the support shaft 4 in the axial direction is restricted.

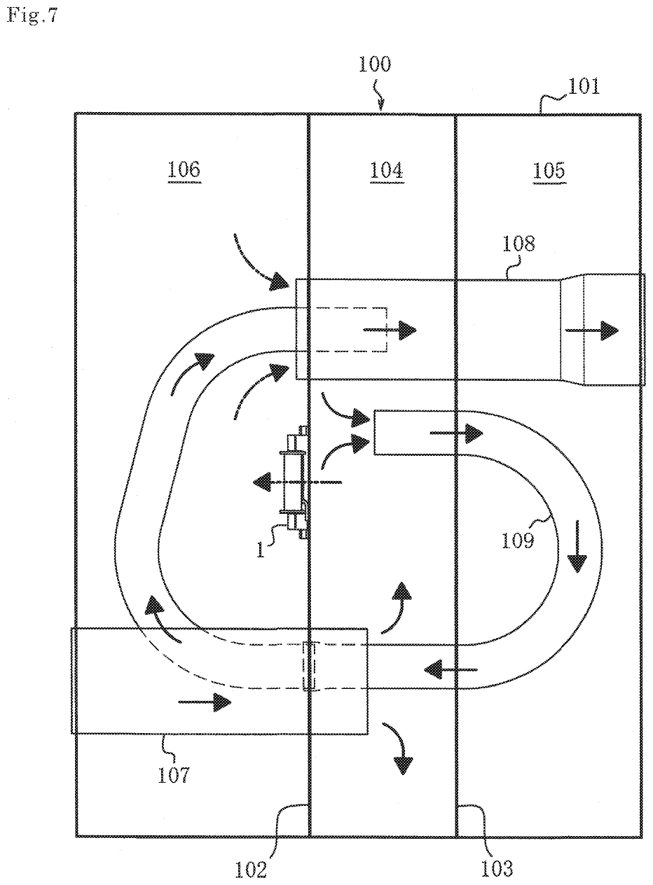

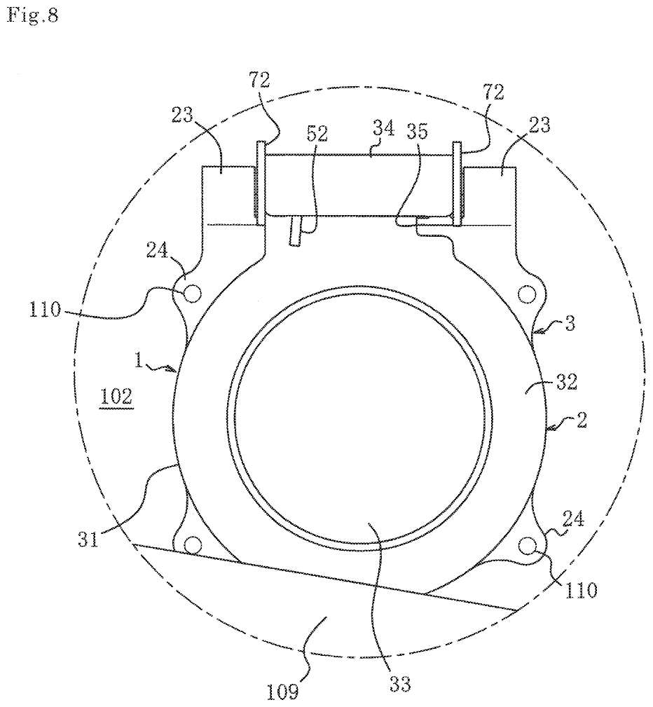

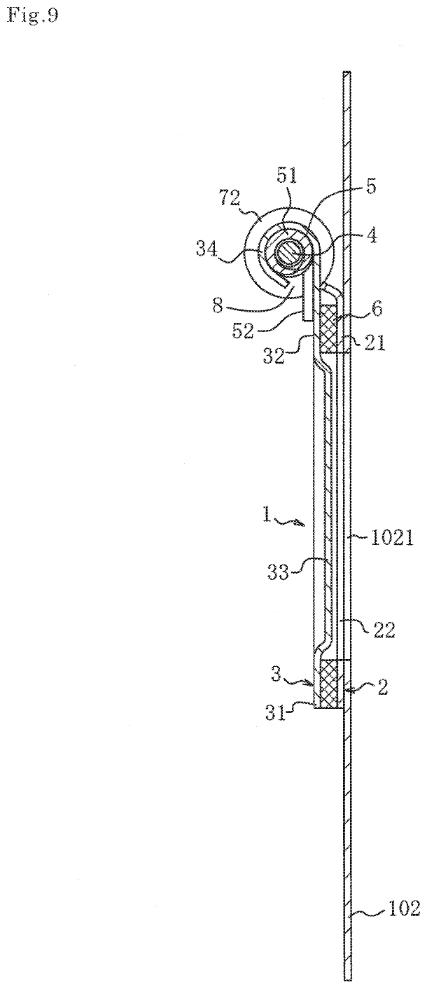

The muffler valve 1 of the present embodiment is preferably used by attaching it to the separator 102 of the muffler 100 shown in FIGS. 7 to 9, for example. In the muffler 100, the inside of the housing 101 is partitioned by a first separator 102 and a second separator 103 having a flat-plate shape, whereby an expansion chamber 104, a resonance chamber 105, and an expansion chamber 106 are provided. A large number of small holes (not shown) are formed over the entire surface of the second separator 103 that partitions the expansion chamber 104 and the resonance chamber 105.

The muffler 100 includes an exhaust introduction pipe 107 that communicates with an exhaust pipe of the engine and introduces an exhaust gas into the housing 101, and an exhaust outlet pipe 108 that leads out an exhaust gas from the housing 101. The exhaust introduction pipe 107 is provided so as to pass through the first separator 102 so as to cross the expansion chamber 106 from the outer wall on the expansion chamber 106 side, and the expansion chamber 104 serves as an exhaust port of the exhaust introduction pipe 107. The exhaust outlet pipe 108 is provided so as to pass through the second separator 103 and the first separator 102 so as to cross the resonance chamber 105 and the expansion chamber 104 with the outer wall on the resonance chamber 105 side as an exhaust port, and the expansion chamber 106 serves as an inlet port of the exhaust outlet pipe 108.

An exhaust distribution pipe 109 that bends in a substantially σ-shape is provided in the housing 101, and the exhaust distribution pipe 109 is formed to have a smaller diameter than the exhaust introduction pipe 107 and the exhaust outlet pipe 108. The exhaust distribution pipe 109 has an intake port opened to the expansion chamber 104, and is disposed so as to pass through the second separator 103 at two locations on the inlet side and the outlet side and cross the resonance chamber 105 in a substantially arc shape. The exhaust distribution pipe 109 is disposed so as to cross the expansion chamber 104 and pass through the first separator 102. The exhaust distribution pipe 109 is curved so as to fold back in the expansion chamber 106, so that the exhaust port is disposed near the inlet of the exhaust outlet pipe 108.

The muffler valve 1 is provided on the expansion chamber 106 side of the first separator 102, and is disposed so as to close the opening 1021 at a position corresponding to the opening 1021 which serves as an exhaust passage of the first separator 102. In the muffler valve 1, the valve seat substrate 21 having a substantially flat-plate ring shape is disposed so as to correspond to the peripheral edge of the opening 1021 of the first separator 102. The valve seat substrate 21 is welded at a welding portion 110 such as spot welding in the welding regions 24 of the valve seat substrate 21. The valve seat substrate 21 is fixed to the peripheral edge of the opening 1021 of the first separator 102.

In the muffler 100, when the pressure of an exhaust gas of the engine is less than a predetermined pressure, the exhaust gas flows as indicated by the thick solid line arrow in FIG. 7. The exhaust gas flows in the order, from the exhaust introduction pipe 107, to the expansion chamber 104, the exhaust distribution pipe 109 in the expansion chamber 104, the exhaust distribution pipe 109 in the resonance chamber 105, the exhaust distribution pipe 109 in the expansion chamber 104, the exhaust distribution pipe 109 in the expansion chamber 106, and the exhaust outlet pipe 108. At this time, the valve body 3 of the muffler valve 1 is continuously urged by the coil spring 5 in the closing direction, valve body 3 is maintained in the closed state, and a high sound deadening effect is exhibited.

When the pressure of an exhaust gas of the engine is equal to or higher than a predetermined pressure in the muffler 100, the valve body 3 of the muffler valve 1 is opened by the pressure of the exhaust gas against the urging of the coil spring 5 in the closing direction. In addition to the flow of the exhaust gas of the thick solid line arrow in FIG. 7, the flow of the exhaust gas of the thick two-dot chain line arrow is generated. That is, the flow of the exhaust gas flowing in the order, from the exhaust introduction pipe 107, to the expansion chamber 104, the exhaust passage of the muffler valve 1 in the open state, the expansion chamber 106, the gap between the exhaust distribution pipe 109 and the exhaust outlet pipe 108, and the exhaust outlet pipe 108 is added, and the back pressure of the exhaust gas of the engine is reduced. After that, when the pressure of an exhaust gas of the engine drops below a predetermined pressure, the valve body 3 closes while being buffered by the ring cushioning member 6, and the valve body substrate 31 abuts on the valve seat substrate 21 via the ring cushioning member 6.

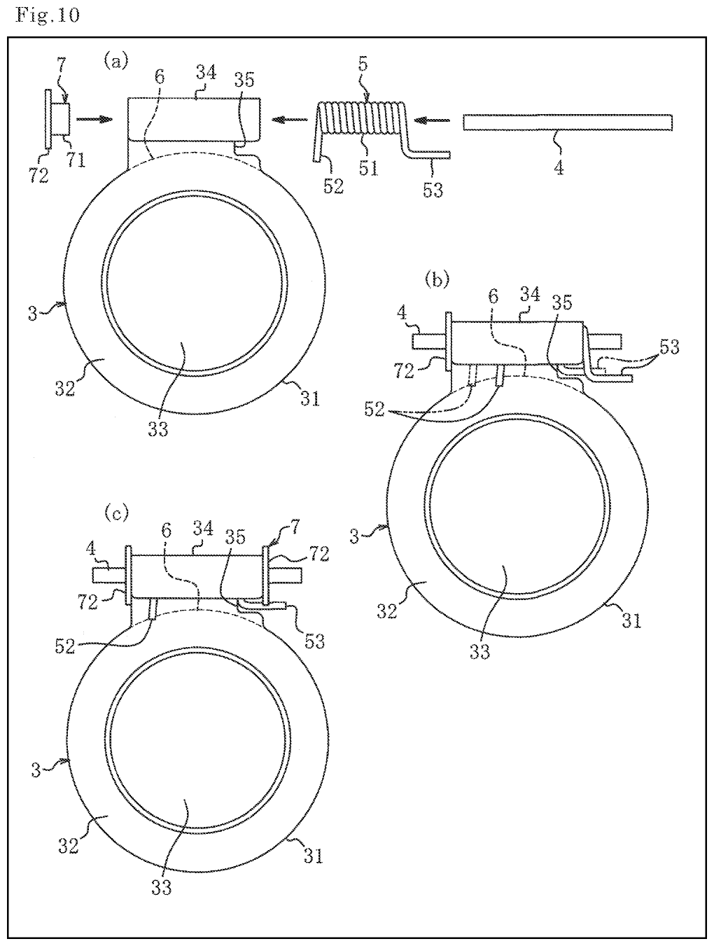

When the muffler valve 1 of the present embodiment is manufactured, for example, as shown in FIG. 10(a), the ring cushioning member 6 having a substantially flat-plate ring shape is fixed, by spot welding, to the flat rim 32 of the valve body 3 formed in a predetermined shape having the valve body winding portion 34 and the notch 35. The cylindrical portion 71 of one cylinder cushioning member 7 is internally fitted to the valve body winding portion 34 of the valve body 3 from the side opposite to the notch 35 in the width direction, and the flange 72 is disposed so as to be in contact with or close to the end surface of the valve body winding portion 34.

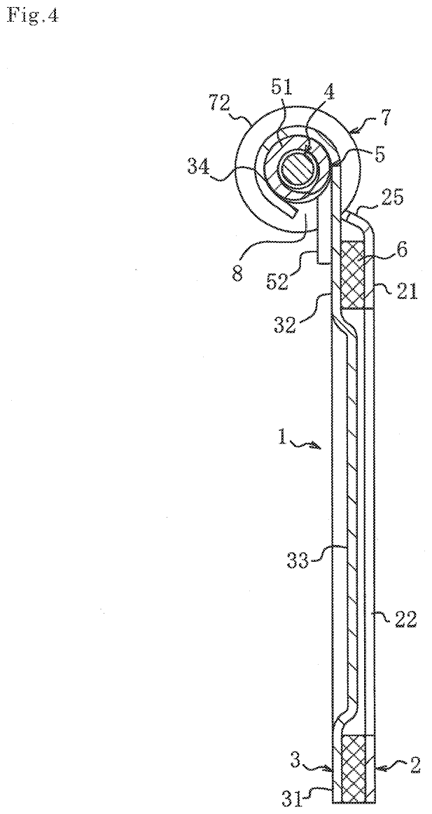

One arm 52 of the coil spring 5 is inserted into the gap 8 between the tip surface of the valve body winding portion 34 and the valve body substrate 31 from the notch 35 side in the width direction so that the coil spring 5 or the coil body 51 is inserted into the valve body winding portion 34. The support shaft 4 is inserted into the valve body winding portion 34 so as to be inserted into the coil body 51 of the coil spring 5, and the support shaft 4 is inserted through one cylinder cushioning member 7 (see FIGS. 4, 9, 10(a) and 10(b)). The coil spring 5 or the coil body 51 is inserted into the valve body winding portion 34 until the other arm 53 is in contact with or close to the end surface of the notch 35 and reaches a predetermined position near the tip of the cylindrical portion 71 of the cylinder cushioning member 7. At this time, the notch 35 functions as a positioning portion for the insertion position of the coil spring 5.

After that, the cylindrical portion 71 of the other cylindrical cushioning member 7 is internally fitted to the valve body winding portion 34 of the valve body 3 from the notch 35 side in the width direction, and the flange 72 is disposed so as to be in contact with or close to the end surface of the valve body winding portion 34 (see FIG. 10(c)). When the other cylinder cushioning member 7 is disposed, the ends of the support shaft 4 protrude from both cylinder cushioning members 7.

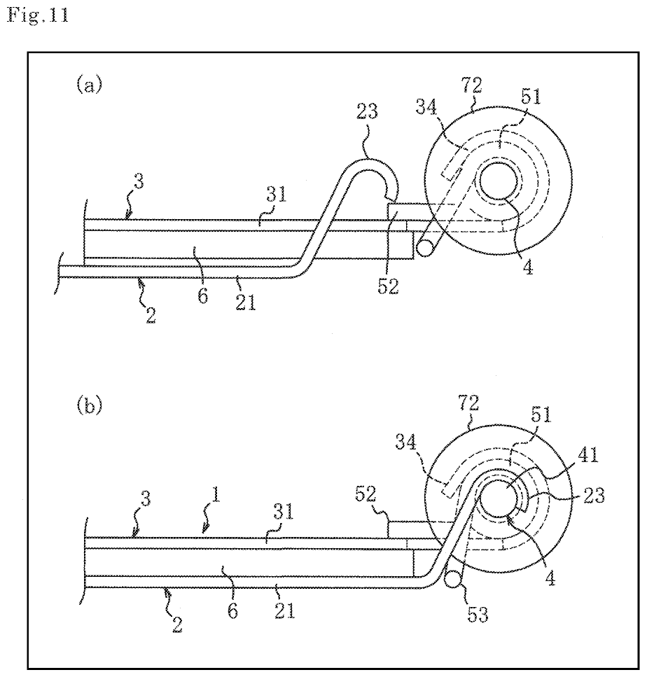

After that, the valve seat 2 formed in a predetermined shape having a pair of valve seat hook portions 23, 23 is disposed on the back side of the valve body 3, and the valve seat hook portions 23, 23 are engaged with the ends of the support shaft 4, respectively. Both ends of the support shaft 4 are welded to the valve seat hook portions 23, 23 to form the welding portions 41 to obtain the muffler valve 1 of the present embodiment (see FIGS. 11(a) and 11(b)). At this time, the restricting protrusion 26 of the valve seat 2 is disposed so that the other arm 53 of the coil spring 5 is sandwiched between the inner end surface of the restricting protrusion 26 and the end surface of the notch 35.

According to the muffler valve 1 of the present embodiment, the valve seat hook portion 23 of the valve seat 2 is provided so as to embrace both ends of the support shaft 4 in the circumferential direction and is fixed to the support shaft 4. The valve body winding portion 34 is provided so as to embrace the coil spring 5 in the circumferential direction from the direction opposite to the valve seat hook portion 23 and to embrace the coil spring 5 in the circumferential direction over the entire length of the coil spring 5. Therefore, it is possible to prevent or suppress axial misalignment of the coil body 51 of the coil spring 5 externally inserted on the support shaft 4 for opening and closing the valve body so as to be coaxial with the support shaft 4 as much as possible and appropriately control the opening and closing of the valve body 3 with high stability. In addition, by preventing and suppressing axial misalignment as much as possible, it is possible to reduce the number of prototypes when developing an improved product of the muffler valve 1 that meets detailed product specification changes, thereby reducing development costs and shortening the development period. In addition, since it is possible to assemble by inserting the coil spring 5 and the support shaft 4 into the valve body winding portion 34, it is possible to reduce the number of jigs for positioning and holding the parts used during manufacturing and reduce manufacturing costs and increase manufacturing efficiency by simplifying the manufacturing process.

One arm 52 of the coil spring 5 is led out and disposed on the front side of the valve body substrate 31 of the valve body 3 near the root of the valve body winding portion 34, and the other arm 53 is led out and disposed on the back side near the root of the valve seat hook portion 23 so that the valve body 3 is urged in the closing direction by one arm 52. Therefore, the valve body 3 provided so that the valve body winding portion 34 embraces the coil spring 5 in the circumferential direction can be always urged in the closing direction.

In addition, due to the notch 35, the other arm 53 of the coil spring 5 can be easily led out to the back side near the root of the valve seat hook portion 23 while providing the valve body winding portion 34 so as to embrace the coil spring 5 in the circumferential direction over the entire length. In addition, by using the notch 35 instead of the hole as the position at which the other arm 53 is led out to the back side, the muffler valve 1 can be smoothly assembled with a simple manufacturing process by externally inserting the coil spring 5 on the support shaft 4 from the notch 35 side.

In addition, the restricting protrusion 26 that restricts the movement of the other arm 53 of the coil spring 5 in the axial direction of the support shaft at a position inner than the valve seat hook portion 23 of the valve seat 2. Therefore, it is possible to restrict the movement of the coil spring 5 in the axial direction of the support shaft and enhance the stability of the operation of opening and closing the valve body 3 of the muffler valve 1.

The valve seat hook portion 23 is provided so as to embrace both ends of the support shaft 4 in the circumferential direction from the valve body 3 side and is fixed to the support shaft 4. The valve body winding portion 34 is provided so as to embrace the coil spring 5 in the circumferential direction from the valve seat 2 side and protrude from the valve body substrate 31 of the valve body 3 in the direction opposite to the valve seat 2. Therefore, it is possible to prevent and suppress axial misalignment of the coil spring 5 externally inserted on the support shaft 4 for opening and closing the valve body so as to be coaxial with the support shaft 4 as much as possible. Moreover, it is possible to eliminate the bulkiness of the valve body winding portion 34 toward the valve seat 2 side, reduce the thickness of the valve body substrate 31 of the valve body 3 and the valve seat 2, and enhance handleability when the muffler valve 1 is attached to the separator 102 or the like.

The valve seat substrate 21 of the valve seat 2 of the muffler valve 1 is formed in a substantially flat-plate ring shape having the opening 22 at the center, and the valve body substrate 31 of the valve body 3 is formed in a flat dish shape having the flat rim 32. As a result, the muffler valve 1 can be made compact by eliminating the bulkiness and minimizing the thickness. Therefore, the handleability of the muffler valve 1 during attachment can be improved. In addition, the materials used for manufacturing can be reduced, the manufacturing cost can be reduced, and the weight can be reduced as the materials used are reduced, which can contribute to the improvement of the fuel efficiency of the automobile. When the muffler valve 1 is attached to the separator 102 that partitions the inside of the muffler 100, for example, the flat-plate ring-shaped valve seat substrate 21 can be disposed and attached near the peripheral edge of the opening 1021 of the separator 102, eliminating the need for additional machining such as forming a flange in the opening 1021 of the separator 102. From this point of view, it is possible to reduce the manufacturing cost of the muffler 100 and improve the manufacturing efficiency. Since a portion of the separator is not cut up to reduce the strength of the separator and the separator is not repeatedly subjected to bending stress, it is possible to maintain the high durability of the muffler 100.

When the muffler valve 1 is manufactured, the coil spring 5 is inserted into the valve body winding portion 34 so that one arm 52 of the coil spring 5 is inserted into the gap 8 between the tip surface of the valve body winding portion 34 and the valve body substrate 31, and the support shaft 4 is inserted into the valve body winding portion 34 so as to be inserted into the coil body 51 of the coil spring 5. As a result, it is possible to reduce the number of jigs for positioning and holding the parts to be used, such as, for example, jigs for positioning and holding the coil spring. Therefore, it is possible to reduce the manufacturing costs of the muffler valve 1 capable of preventing or suppressing the axial misalignment of the coil body 51 of the coil spring 5 externally inserted on the support shaft 4 for opening and closing the valve body so as to be coaxial with the support shaft 4 as much as possible and enhance the manufacturing efficiency by simplifying the manufacturing process.

### [Scope of Inclusion of Invention Disclosed in Present Specification]

The invention disclosed in the present specification includes each invention and each embodiment, and, within an applicable range, an invention specified by changing a partial configuration thereof to another configuration disclosed in the present specification, an invention specified by adding another configuration disclosed in the present specification to the configuration thereof, and an invention obtained by reducing, specifying and highly conceptualizing the partial configuration thereof as long as a partial effect is acquired. The invention disclosed in the present specification includes the following modified embodiments and postscripts.

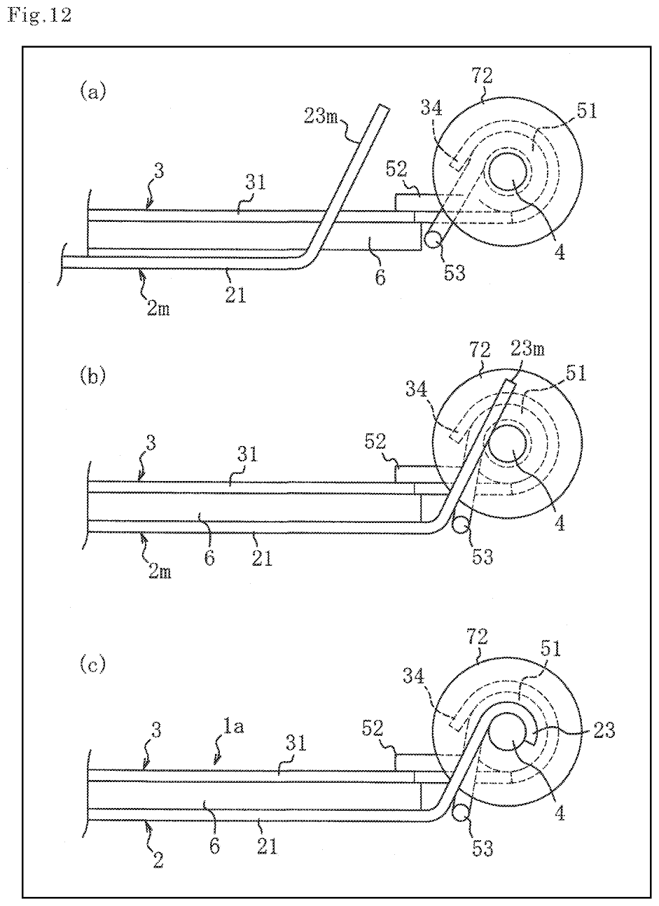

For example, in the manufacturing process example of the muffler valve 1 of the above-described embodiment, as a preferred example, a process has been described in which the valve seat 2 formed in a predetermined shape having a pair of valve seat hook portions 23, 23 is disposed on the back side of the valve body 3, the valve seat hook portions 23, 23 are engaged with the ends of the support shaft 4, both ends of the support shaft 4 are welded to the valve seat hook portions 23, 23 to form the welding portions 41. As another process example, as illustrated in FIGS. 12(a) to 12(c), a valve seat intermediate body 2m may be used in which a portion serving as the pair of valve seat hook portions 23, 23 is modified to upright pieces 23m, 23m extending obliquely upward and the other portions are formed in the predetermined shape of the valve seat 2. The upright pieces 23m are pressed against both ends of the support shaft 4 so that the other arm 53 of the coil spring 5 is pressed by the upright piece 23m positioned on the notch 35 side while arranging the valve seat intermediate body 2m on the back side of the valve body 3. The upright pieces 23m, 23m are bent and engaged with both ends of the support shaft 4, the valve seat hook portions 23, 23 are provided so as to embrace both ends of the support shaft 4 in the circumferential direction from the valve body 3 side and is fixed to the support shaft 4 by caulking. In this way, a muffler valve la may be obtained. In the case of the muffler valve la that is fixed by caulking, it may be preferable to enhance the efficiency of the manufacturing process without forming the welding portion 41. However, it may be also preferable to further enhance the fixing strength of the support shaft 4 and the valve seat hook portion 23 by fixing with the welding portion 41 in addition to caulking.

Further, in the above-described embodiment, the ring cushioning member 6 having a substantially flat-plate ring shape is fixed to the valve seat 2 side of the flat rim 32 of the valve body substrate 31. However, the ring cushioning member 6 may be fixed to the valve seat substrate 21, and the ring cushioning member 6 may not be fixed to the valve seat 2 side of the flat rim 32 of the valve body substrate 31. As the configuration of fixing the valve seat substrate of the muffler valve of the present invention to the peripheral edge of the opening of the separator of the muffler, an appropriate fixing configuration can be used within the scope of the purpose of the present invention in addition to welding at the welding portions 110 of the welding regions 24. The muffler valve of the present invention is preferably a muffler valve attached to a separator that partitions the inside of the muffler, but the muffler valve may also be attached to the end of an exhaust pipe installed in the muffler. It is also possible to install the muffler valve at an appropriate place in the exhaust passage within an applicable range.

### INDUSTRIAL APPLICABILITY

The present invention can be used, for example, as a muffler valve attached to a separator that partitions the inside of a muffler of an exhaust system of an automobile.

### REFERENCE SIGNS LIST

1, 1a Muffler valve
2 Valve seat
21 Valve seat substrate
22 Opening
23 Valve seat hook portion
24 Welding region
25 Upright portion
26 Restricting protrusion
3 Valve body
31 Valve body substrate
32 Flat rim
33 Recess
34 Valve body winding portion
35 Notch
4 Support shaft
41 Welding portion
5 Coil spring
51 Coil body
52 One arm
53 The other arm
6 Ring cushioning member
7 Cylinder cushioning member
71 Cylindrical portion
72 Flange
8 Gap
2m Valve seat intermediate body
23m Upright piece
100 Muffler
101 Housing
102 First separator
1021 Opening
103 Second separator
104 Expansion chamber
105 Resonance chamber
106 Expansion chamber
107 Exhaust introduction pipe
108 Exhaust outlet pipe
109 Exhaust distribution pipe
110 Welding portion

1. A muffler valve that opens and closes an exhaust passage according to a pressure of an exhaust gas of an engine, wherein
a valve body is swingably supported by a support shaft with respect to a valve seat having an opening,
the valve body is urged in a closing direction by a coil spring externally inserted on the support shaft,
a valve seat hook portion is provided so as to embrace both ends of the support shaft in a circumferential direction and is fixed to the support shaft, and
a valve body winding portion is provided so as to embrace the coil spring in the circumferential direction from a direction opposite to the valve seat hook portion and embrace the coil spring over an entire length of the coil spring in the circumferential direction.

2. The muffler valve according to claim 1, wherein
one arm of the coil spring is led out and disposed on a front side of the valve body substrate of the valve body near a root of the valve body winding portion, and the other arm is led out and disposed on a back side near a root of the valve seat hook portion, and
the valve body is urged in a closing direction by one arm of the coil spring.

3. The muffler valve according to claim 2, wherein
a notch in which the other arm of the coil spring is led out to the back side near the root of the valve seat hook portion is formed in the valve body substrate near a rising portion of the valve body winding portion of the valve body.

4. The muffler valve according to claim 3, wherein
a restricting projection that restricts movement of the other arm of the coil spring in an axial direction of a support shaft is provided at a position inner than the valve seat hook portion of the valve seat.

5. The muffler valve according to claim 1, wherein
the valve seat hook portion is provided so as to embrace both ends of the support shaft in the circumferential direction from the valve body side and is fixed to the support shaft, and
the valve body winding portion is provided so as to embrace the coil spring in the circumferential direction from the valve seat side, and is provided so as to protrude from the valve body substrate of the valve body in a direction opposite to the valve seat.

6. The muffler valve according to claim 1, wherein
the valve seat substrate of the valve seat is formed in a substantially flat-plate ring shape having an opening at the center, and
the valve body substrate of the valve body is formed in a flat dish shape having a flat rim.

7. A muffler in which the valve seat substrate of the valve seat of the muffler valve according to claim 1 is fixed to a peripheral edge of an opening of a separator that partitions the inside of the muffler.

8. A method for manufacturing the muffler valve according to claim 1, comprising:
a process of inserting the coil spring into the valve body winding portion so that one arm of the coil spring is inserted into a gap between the valve body substrate and a tip surface of the valve body winding portion formed by being bent in a hook shape so as to be folded back from the valve body substrate of the valve body and inserting the support shaft into the valve body winding portion so as to be inserted into the coil body of the coil spring.

9. The muffler valve according to claim 2, wherein
the valve seat hook portion is provided so as to embrace both ends of the support shaft in the circumferential direction from the valve body side and is fixed to the support shaft, and
the valve body winding portion is provided so as to embrace the coil spring in the circumferential direction from the valve seat side, and is provided so as to protrude from the valve body substrate of the valve body in a direction opposite to the valve seat.

10. The muffler valve according to claim 3, wherein
the valve seat hook portion is provided so as to embrace both ends of the support shaft in the circumferential direction from the valve body side and is fixed to the support shaft, and
the valve body winding portion is provided so as to embrace the coil spring in the circumferential direction from the valve seat side, and is provided so as to protrude from the valve body substrate of the valve body in a direction opposite to the valve seat.

11. The muffler valve according to claim 4, wherein
the valve seat hook portion is provided so as to embrace both ends of the support shaft in the circumferential direction from the valve body side and is fixed to the support shaft, and
the valve body winding portion is provided so as to embrace the coil spring in the circumferential direction from the valve seat side, and is provided so as to protrude from the valve body substrate of the valve body in a direction opposite to the valve seat.

12. The muffler valve according to claim 2, wherein
the valve seat substrate of the valve seat is formed in a substantially flat-plate ring shape having an opening at the center, and
the valve body substrate of the valve body is formed in a flat dish shape having a flat rim.

13. The muffler valve according to claim 3, wherein
the valve seat substrate of the valve seat is formed in a substantially flat-plate ring shape having an opening at the center, and
the valve body substrate of the valve body is formed in a flat dish shape having a flat rim.

14. The muffler valve according to claim 4, wherein
the valve seat substrate of the valve seat is formed in a substantially flat-plate ring shape having an opening at the center, and
the valve body substrate of the valve body is formed in a flat dish shape having a flat rim.

15. The muffler valve according to claim 5, wherein
the valve seat substrate of the valve seat is formed in a substantially flat-plate ring shape having an opening at the center, and
the valve body substrate of the valve body is formed in a flat dish shape having a flat rim.

16. The muffler valve according to claim 6, wherein
the valve seat substrate of the valve seat is formed in a substantially flat-plate ring shape having an opening at the center, and
the valve body substrate of the valve body is formed in a flat dish shape having a flat rim.

17. The muffler valve according to claim 7, wherein
the valve seat substrate of the valve seat is formed in a substantially flat-plate ring shape having an opening at the center, and
the valve body substrate of the valve body is formed in a flat dish shape having a flat rim.

18. The muffler valve according to claim 8, wherein
the valve seat substrate of the valve seat is formed in a substantially flat-plate ring shape having an opening at the center, and
the valve body substrate of the valve body is formed in a flat dish shape having a flat rim.
